(19) United States
(12) Patent Application Publication
(10) Pub. No.: US 2007/0055658 A1
(43) Pub. Date: Mar. 8, 2007

(54) EFFICIENT ACCESS CONTROL ENFORCEMENT IN A CONTENT MANAGEMENT ENVIRONMENT

(75) Inventors: HUI-I HSIAO, SARATOGA, CA (US); SRIRAM RAGHAVAN, SAN JOSE, CA (US)

Correspondence Address: LACASSE & ASSOCIATES, LLC, 1725 DUKE STREET, SUITE 650, ALEXANDRIA, VA, 22314, US

(73) Assignee: INTERNATIONAL BUSINESS MACHINES CORPORATION, ARMONK, NY (US)

(21) Appl. No.: 11/162,395

(22) Filed: Sep. 8, 2005

(51) Int. Cl. G06F 17/30

(52) U.S. Cl. 707/4

(57) ABSTRACT

Provided is a system and method for optimizing CM through application-level optimization by exploiting the specific semantics of access control. Access control is enforced by rewriting user or application queries to include additional predicates. Portions of a complex CM query that are identified as those that will return an empty set of result objects are replaced by an empty or null expression. Furthermore, statistics specific to access control are collected and intelligently used in formulating the rewritten query and in controlling the order of evaluation of access control predicates. Optionally, rewriting can generate a result filter in addition to a rewritten query. This filter is applied to the results produced by executing the rewritten query, thus allowing the access control enforcement burden to be shared between the query and the filter. When combined, the aforementioned techniques serve to reduce the runtime overhead of access control enforcement in CM systems.

### BACKGROUND OF THE INVENTION

The present invention relates generally to the field of access control enforcement in a database environment. More specifically, the present invention is related to reducing runtime overhead of access control enforcement in content management systems.

### DISCUSSION OF PRIOR ART

The ability to control the access and operations on content resources is a vital feature of a content management (CM) system. Access control designed for a CM system will typically include an administration component for defining users, roles, policies, and rules as well an enforcement component for enforcing those rules and policies as resources are created, manipulated, and retrieved. The act of enforcing access control rules causes additional overhead when executing operations within the CM system. Such overhead becomes a particularly critical problem when queries are executed on large enterprise-scale CM systems containing several hundred million objects and thousands of access control rules. Thus, there is a need in the art for an optimization framework and an associated suite of techniques for reducing the runtime overhead of access control enforcement, in particular, during query-based retrieval of content resources from large-scale CM systems.

Current methods address runtime overhead associated with access control enforcement in a number of ways. However, as discussed below, the methods are either limited to specific data models and database query languages (such as XQuery) or limited in terms of their applicability to large-scale systems.

There are two broad classes of techniques for access control enforcement: those based on query rewrite and techniques based on the concept of security views.

U.S. Patent Application Publication 2005/0038783 A1, assigned to Lei et al., discloses an access control enforcement method, based on the query rewrite approach. This method provides for executing a modified query, wherein an original database query is modified by adding one or more predicates. The additional predicates reflect the characteristics of the application or user requesting execution of the query. Executing the modified query results in minimizing the size of the returned result set. More specifically, the additional predicates act as a further restriction on the records that are returned as a part of the result set, thereby effectively providing access control. In general, there are multiple ways in which such a modified query could be generated all of which are semantically equivalent but different with respect to evaluation time. However, the Lei method is limited in that, such alternative ways are not considered. Furthermore, no attempt is made to optimize the evaluation order of these access control predicates by using access control-specific statistics on users, user groups, object types, etc.

“Secure XML querying with security views” by Fan, Chan, and Garofalakis describes a paradigm for specifying and enforcing XML security constraints through the use of security views. The disclosed security views consist of all the information and only the information that the users are authorized to access. Furthermore, algorithms are presented for XPath query rewriting and optimization such that queries over security views are efficiently answered without the requirement of materializing views. However, the method presented is limited in that the disclosed rewrite and optimization is specific to XML queries. Furthermore, since the method requires the creation and maintenance of at least one view per every user and user group registered with the system, its applicability in large enterprise-scale systems, where the number of such views can be in the 1000's, is limited. This limitation is applicable in general for all methods based on security views.

Whatever the precise merits, features, and advantages of the above cited references, none of them achieves or fulfills the purposes of the present invention. Thus, there is a need in the art for a generalized architecture for access control in a CM environment, one that is neither dependant on a specific data model nor a specific query language, and can scale to the requirements of large enterprise content management systems.

### SUMMARY OF THE INVENTION

The present invention provides a general-purpose architecture for optimizing query rewrite-based access control enforcement through the concept of application-level optimization, exploiting the semantics of access control. While the architecture is general-purpose and applies to any CM system, a specific instantiation of this architecture is predicated on the knowledge of the data and query model exposed by the CM system under question.

Specifically, queries are rewritten using access control rules that are defined for a particular user, user-group, or object type. Based on the user and application requesting the execution of the query and the object or objects being requested, additional predicates are constructed and added to a query as it was originally issued by a user or application.

Access control statistics are collected to assist in query rewrite. These statistics are indicative of a current environment; measures of the total number of objects a user has access to, the number of objects of a particular type that a user has access to, number of members in a particular user-group, and so on. The system and method of the present invention intelligently utilizes these statistics in constructing additional predicates for rewriting a query. It is emphasized that these statistics are additional to any statistics that may be collected by a relational DBMS that underlies the CM system.

Additionally, the architecture incorporates a static analysis step to further optimize the construction and evaluation of these additional predicates. The goal of static optimization is to identify portions of a complex CM query that will return an empty set of result objects as a result of access control restrictions. Those portions that will return an empty set of result objects are replaced by an empty or null expression.

Lastly, the architecture incorporates a result filter that may also be generated for each user or application query. If a non-null result filter is generated, it is applied to the dataset that results from the execution of a rewritten query before results are returned to the original user or application The architecture proposed in this invention, in combination with these techniques serve to reduce the runtime overhead of access control enforcement in CM systems.

### BRIEF DESCRIPTION OF THE DRAWINGS

FIG. 1a illustrates access control enforcement within the framework of a query processing architecture of a CM system.

FIG. 1b illustrates the architecture of the proposed access control enforcement system.

FIG. 2 is a process flow diagram illustrating query rewrite, optimization, and evaluation.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

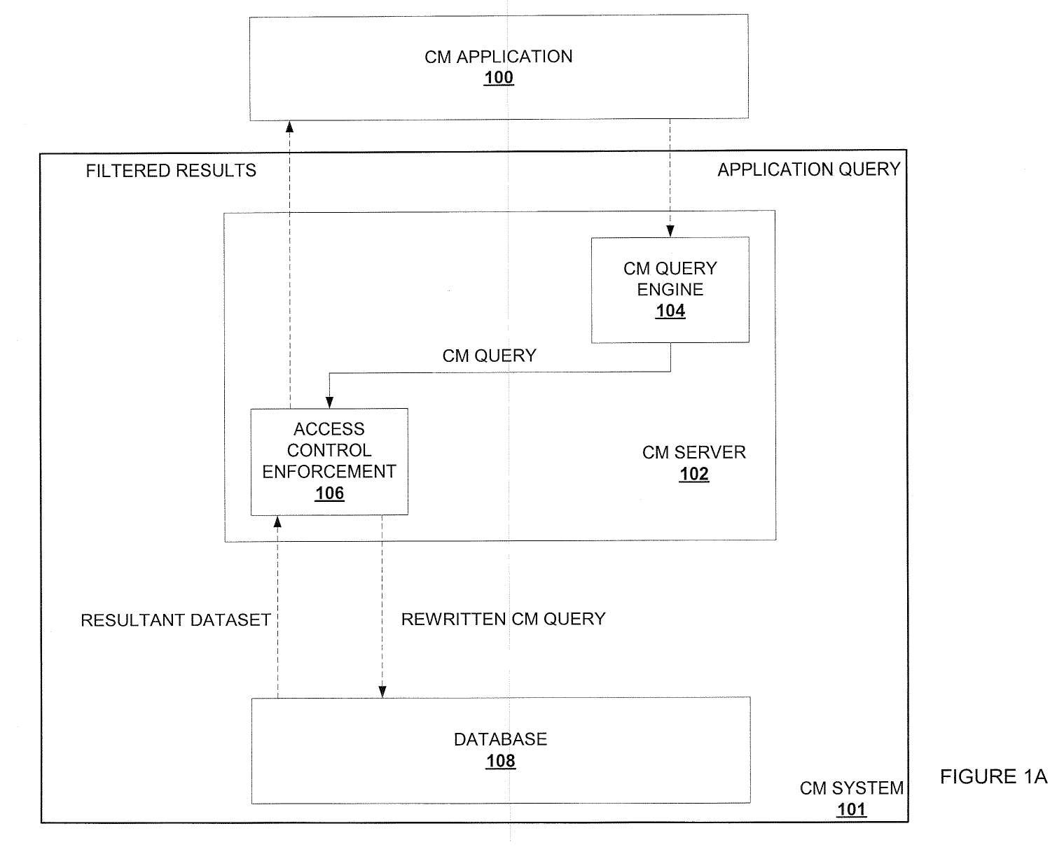

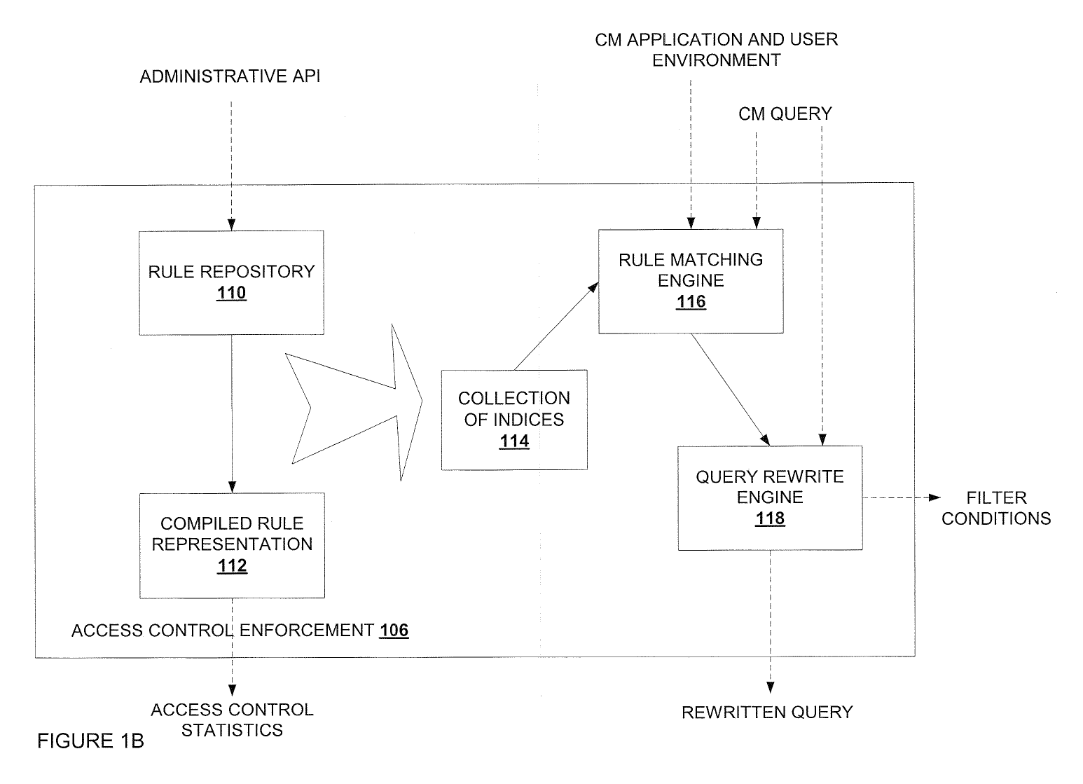

The overall query processing architecture is shown in FIG. 1a. A CM application 100 requests that a query be executed against a CM system 101. The application query is first provided to the CM server 102; within the CM server 102, the application query is first received by the CM query engine 104. The CM query engine converts the application query into a CM query based on its knowledge of the CM data model and other CM features such as workspaces, versioning, work-flow, etc. The specific details of 104 may differ from one CM system to another but the precise details are not relevant to this invention. The CM query is then provided to Access Control Enforcement component 106 where the CM query is rewritten. Finally, the rewritten CM query is executed against database 108. The resultant set of objects is then returned to access control enforcement component 106. Subsequently, access control enforcement component 106 filters the resultant set of objects and returns the remaining objects in the resultant set to the user of CM application 100.

Referring now to FIG. 1b, a detailed internal architecture of the access control enforcement component of the present invention is shown. Access control enforcement component 106 uses query rewrite to incorporate access control information into a received CM query. Rule Repository component 110 is responsible for interacting with the access control administrative API to maintain a repository of currently active access control policies including user and user-group definitions as well as actual access control rules for these users and user-groups. The collection of active rules at any time is represented internally as a compiled rule representation 112 using a data structure specific to the access control enforcement component. In one embodiment, decision tree data structures and mathematical structures known as tree automata are used for representing compiled access control policies. The latter is particularly useful for CM systems that expose an XQuery/XPath query interface since XML schemas, XQuery expressions, and XML documents can all be expressed as tree automata. The compiled rule representation also incorporates all of the access control statistics that may be relevant to the current set of rules stored in the Rule Repository 110.

A collection of indices 114 is built on this compiled rule representation 112 to enable quick access to the collection of rules applicable to a particular user, user-group, or object-type. Given a CM query, information about user credentials, and environmental conditions including, but not limited to: time of day, client application, and client host; Rule Matching Engine 116 identifies a set of access control rules that are relevant to the current scenario using the collection of indices 114. Finally, using the rules supplied by Rule Matching Engine 116 and the original CM query, Query Rewrite Engine 118 component produces two outputs: a rewritten CM query incorporating access control restrictions that is directly sent to the underlying database 108, and a set of filter conditions to be applied to the database result to further prune the set of objects returned to CM application 100.

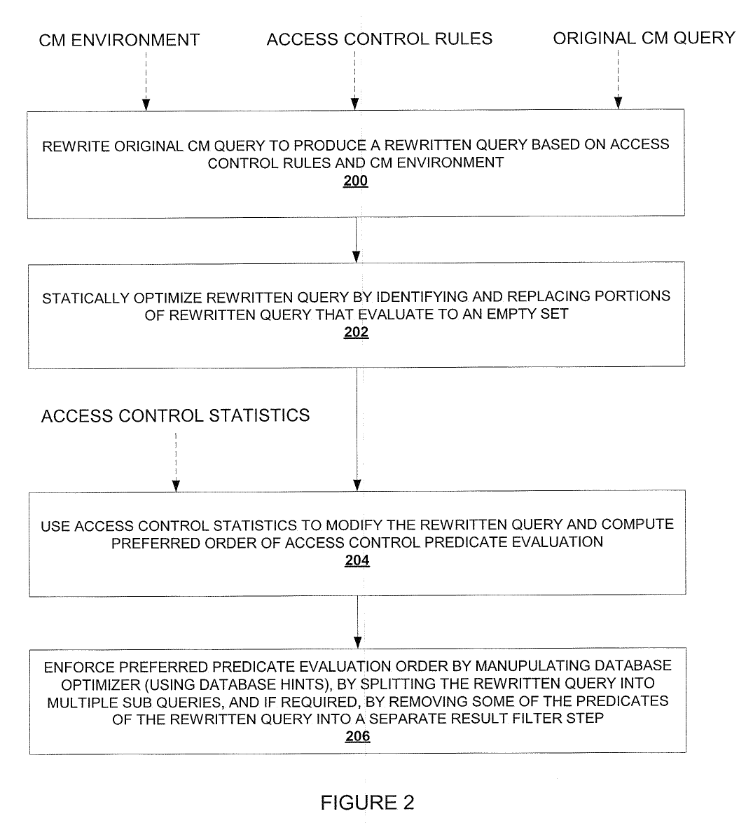

Shown in FIG. 2 is a method flow diagram illustrating, in detail, the sequence of steps performed in the query rewrite engine. Specifically, Query Rewrite Engine 118 implicitly incorporates access control restrictions into a rewritten CM query as either additional predicates or clauses within a CM query in step 200.

In step 202, static analysis is performed on this rewritten query. During this analysis, every query predicate and every query expression is analyzed in the context of a current user's execution privileges and the complete set of access control policy definitions. The goal is to identify, merely by looking at a query predicate and a set of access control rules, those predicates that would retrieve an object or set of objects that a user does not have permission to access. For example, consider an exemplary CM repository organized at a top-level by business unit wherein top-most categories are comprised of Sales, Marketing, Finance, IT, and HR. Additionally access control says that members of group IT-Supplemental are only allowed to read an object of IT document type. Then an XPath query /Sales/Reports/Charts issued by a user who belongs to the IT-Supplemental group is statically analyzed and replaced by an empty or null expression.

As indicated earlier in FIG. 1B, access-control specific statistics are collected and maintained along with the compiled rules in the rule repository 112. In the optimization stage, in step 204, these statistics are used to efficient rewritten queries that incorporate a preferred predicate evaluation order. Once again, these statistics are additional to statistics that would typically be collected by an underlying relational DBMS. Access-control specific statistics include, but are not limited to: the number of objects that a user has access to within a specific sub-tree of the repository; the number of objects of a particular type that a user owns, the total number of objects of a particular type that members of a group can access, and so on. For instance, consider the following XPath query,

/Sales/Databases[@type=‘Presentation Charts’]. Assume a repository in which over fifteen hundred objects of type Presentation Chart are contained, and of which five hundred objects are located in the /Sales/Databases sub-tree. Given these statistics, an underlying database is likely to first evaluate the path expression /Sales/Databases/ and then check for the predicate type=Presentation Charts. However, suppose there exists an access control rule that indicates that user Joe only has access to objects of type Presentation Charts created by users Joe and Jason and additionally, that there are statistics available that indicate that the exemplary repository only has seven such objects that Joe is authorized to access. It would be more efficient to first evaluate the query //*[@type=‘Presentation Charts’ AND (@author=‘Joe’ OR @author=‘Jason’] and then filter out from the result those document objects which are not in the /Sales/Databases sub-tree.

In step 206, the preferred order of predicate evaluation, as determined in the previous step is enforced through a combination of techniques. These techniques include guiding the underlying database optimizer towards a particular evaluation order using optimizer hints, splitting the rewritten query into multiple subqueries, and where necessary, moving some of the predicates from the query into a separate result filter step that is implemented within the enforcement component itself

Additionally, the present invention provides for an article of manufacture comprising computer readable program code contained within implementing one or more modules to incorporate access control restrictions into a database query and a result set returned from a database. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) rewriting a query incorporating additional predicates representing access control rules for a user, user-group, or object-type based on static analysis based on statistical optimization information and access control-specific statistics; (b) evaluating predicates in said rewritten query in an optimal order; and (c) filtering, in accordance with access control restrictions, resultant dataset obtained by executing said rewritten query against a database.

### CONCLUSION

A system and method has been shown in the above embodiments for the effective implementation of efficient access control enforcement in a content management environment. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific database.

The above enhancements are implemented in various computing environments. For example, the present invention may be implemented on a conventional IBM PC or equivalent. All programming and data related thereto are stored in computer memory, static or dynamic, and may be retrieved by the user in any of: conventional computer storage. The programming of the present invention may be implemented by one of skill in the art of database programming.

What is claimed is:

1. A system providing access control enforcement for a CM system; said system comprising:
a CM application requesting a first query be executed against a CM system
an access control enforcement component incorporating access control rules for any of:
user, user-group, or object type, into a rewritten query through a semantics-based rewrite of said first query;
a resultant dataset resulting from the execution of said first query against said underlying relational database; and
a query rewrite engine generating a filter for said resultant dataset, thus limiting access to items in said resultant dataset remaining after said filter is applied.

2. A system providing access control enforcement, as per claim 1, wherein said underlying relational database stores XML data.

3. A system providing access control enforcement, as per claim 1, wherein said access control enforcement component comprises: a rule repository component storing said access control rules and a rule matching engine for identifying a subset of said access control rules that are applicable to any of: said user or said application.

4. A system providing access control enforcement, as per claim 3, wherein said query rewrite comprises constructing and adding to said first query at least one additional predicate incorporating said identified subset of access control rules.

5. A system providing access control enforcement, as per claim 3, wherein said access control rules stored in said rule repository component are represented as compiled using any of: decision tree, tree automaton, annotated decision tree, path indices, and accessibility maps data structures.

6. A system providing access control enforcement, as per claim 4, wherein said rewritten query is constructed by utilizing static analyses comprising: access control-specific statistics based on said access control rules applicable to said CM environment and contents of said database; and static optimization identifying and replacing with a null set those predicates in said rewritten query that retrieve a null set based on access control rules applicable to said CM environment.

7. A system providing access control enforcement, as per claim 4, wherein said rewritten query is evaluated in a particular order based on descending order of selectivity wherein said particular order of evaluation is forced by any of: hints on which of said at least one additional predicates to issue first; and splitting said rewritten query into multiple sub-queries such that the most selective sub-query is issued first.

8. A method of enforcing access control rules in a CM system; said method comprising:
a CM application or CM application user requesting a first query be issued against said CM system;
rewriting said first query incorporating access control rules as additional predicates representing a set access control rules applicable a user, user-group, or object-type, wherein said additional predicates are based on static analyses;
evaluating in an optimal order and issuing against a database underlying said CM system, predicates in said rewritten query; and
filtering, in accordance with said access control rules, resultant dataset obtained by executing said rewritten query against said underlying database, thus limiting access to items in said resultant dataset remaining after said filtering step.

9. A method of enforcing access control rules in a CM system, as per claim 8, wherein said underlying relational database stores XML data.

10. A method of enforcing access control rules in a CM system, as per claim 8, wherein said query rewriting step comprises identifying a subset of said access control rules applicable to any of said: CM user or CM application.

11. A method of enforcing access control rules in a CM system, as per claim 10, where said query rewriting step further comprises constructing and adding to said first query, at least one additional predicate incorporating said identified subset of access control rules.

12. A method of enforcing access control rules in a CM system, as per claim 8, wherein a stored, compiled representation of said access control rules is any of: decision tree, tree automaton, annotated decision tree, path index, and accessibility maps data structure.

13. A method of enforcing access control rules in a CM system, as per claim 8, wherein said rewritten query is constructed by utilizing static analyses comprising: access control-specific statistics based on said access control rules applicable to any of said: CM user or CM application and contents of said database; and static optimization identifying and replacing with a null set, those predicates in said rewritten query that retrieve a null set based on access control rules applicable to any of said: CM user or CM application.

14. A method of enforcing access control rules in a CM system, as per claim 8, wherein said optimal order is based on descending order of selectivity wherein said optimal order of evaluation is forced by any of: hints on which of said at least one additional predicates to issue first; and splitting said rewritten query into multiple sub-queries such that the most selective sub-query is issued first.

15. A computer-based method of enforcing access control rules in a CM system; said method comprising:
A CM application or CM application user requesting a first query be issued against said CM system;
rewriting said first query incorporating access control rules as additional predicates representing a set access control rules applicable a user, user-group, or object-type wherein said additional predicates are based on static analyses;
evaluating in an optimal order and issuing against a database underlying said CM system, predicates in said rewritten query; and
filtering, in accordance with said access control rules, resultant dataset obtained by executing said rewritten query against said underlying database.

16. A computer-based method of enforcing access control rules in a CM system, as per claim 15, wherein said underlying relational database stores XML data.

17. A computer-based method of enforcing access control rules in a CM system, as per claim 15, wherein said query rewriting step comprises identifying a subset of said access control rules applicable to any of said: CM user or CM application.

18. A computer-based method of enforcing access control rules in a CM system, as per claim 17, where said query rewriting step further comprises constructing and adding to said first query, at least one additional predicate incorporating said identified subset of access control rules.

19. A computer-based method of enforcing access control rules in a CM system, as per claim 15, wherein a stored, compiled representation of said access control rules is any of: decision tree, tree automaton, annotated decision tree, path index, and accessibility maps data structure.

20. A computer-based method of enforcing access control rules in a CM system, as per claim 15, wherein said rewritten query is constructed by utilizing static analyses comprising: access control-specific statistics based on said access control rules applicable to any of said: CM user or CM application and contents of said database; and static optimization identifying and replacing with a null set, those predicates in said rewritten query that retrieve a null set based on access control rules applicable to any of said: CM user or CM application.

21. A computer-based method of enforcing access control rules in a CM system, as per claim 15, wherein said optimal order is based on descending order of selectivity wherein said optimal order of evaluation is forced by any of: hints on which of said at least one additional predicates to issue first; and splitting said rewritten query into multiple sub-queries such that the most selective sub-query is issued first.

22. An article of manufacture comprising a computer usable medium having computer readable program code embodied therein which implements method of enforcing access control rules in a CM system; said medium comprising modules implementing:
a CM application or CM application user requesting a first query be issued against said CM system;
rewriting said first query incorporating access control rules as additional predicates representing a set access control rules applicable a user, user-group, or object-type, wherein said additional predicates are based on static analyses;
evaluating in an optimal order and issuing against a database underlying said CM system, predicates in said rewritten query; and
filtering, in accordance with said access control rules, resultant dataset obtained by executing said rewritten query against said underlying database, thus limiting access to items in said resultant dataset remaining after said filtering step.

23. An article of manufacture comprising, as per claim 22, wherein said underlying relational database stores XML data.

24. An article of manufacture comprising, as per claim 22, wherein said query rewriting step comprises identifying a subset of said access control rules applicable to any of said: CM user or CM application.

25. An article of manufacture comprising, as per claim 24, where said query rewriting step further comprises constructing and adding to said first query, at least one additional predicate incorporating said identified subset of access control rules.

26. An article of manufacture comprising, as per claim 22, wherein a stored, compiled representation of said access control rules is any of: decision tree, tree automaton, annotated decision tree, path index, and accessibility maps data structure.

27. An article of manufacture comprising, as per claim 22, wherein said rewritten query is constructed by utilizing static analyses comprising: access control-specific statistics based on said access control rules applicable to any of said: CM user or CM application and contents of said database; and static optimization identifying and replacing with a null set, those predicates in said rewritten query that retrieve a null set based on access control rules applicable to any of said: CM user or CM application.

28. An article of manufacture comprising, as per claim 22, wherein said optimal order is based on descending order of selectivity wherein said optimal order of evaluation is forced by any of: hints on which of said at least one additional predicates to issue first; and splitting said rewritten query into multiple sub-queries such that the most selective sub-query is issued first.
